(19) United States
(12) Patent Application Publication
(10) Pub. No.: US 2014/0281172 A1
(43) Pub. Date: Sep. 18, 2014

(54) NONVOLATILE MEMORY DEVICE, ELECTRONIC DEVICE AND COMPUTING SYSTEM INCLUDING THE SAME

(71) Applicant: SAMSUNG ELECTRONICS CO., LTD., Suwon-si (KR)

(72) Inventors: Dong-Young SEO, Suwon-si (KR); Dong Kun Shin, Seoul (KR)

(73) Assignee: SAMSUNG ELECTRONICS CO., LTD., Suwon-si (KR)

(21) Appl. No.: 14/202,554

(22) Filed: Mar. 10, 2014

(30) Foreign Application Priority Data
Mar. 13, 2013 (KR) 10-2013-0026881

(51) Int. Cl. G06F 12/02

(52) U.S. Cl. CPC G06F 12/0246
USPC 711/103

(57) ABSTRACT

A nonvolatile memory device includes a memory onto which a flash translation layer is loaded, a controller, and first and second memory areas. The controller is configured to execute the flash translation layer. The nonvolatile memory is configured to receive write requested data and corresponding category information. The flash translation layer is configured to map a logical address of the write requested data to a physical address, based on the category information, such that the write requested data is selectively stored in one of the first and second memory areas. The category information is based on a storage characteristic of the write requested data.

### CROSS-REFERENCE TO RELATED APPLICATIONS

This application claims priority under 35 U.S.C. §119 to Korean Patent Application No. 10-2013-0026881, filed on Mar. 13, 2013, the disclosure of which is incorporated by reference herein in its entirety.

### TECHNICAL FIELD

Exemplary embodiments of the present inventive concept relate to a nonvolatile memory, and more particularly, to a nonvolatile memory device including a flash translation layer, an electronic device, and a computing system including the same.

### DISCUSSION OF THE RELATED ART

A nonvolatile memory device is a memory device that retains data when the device is powered off. A nonvolatile memory device may be, for example, a ROM (Read Only Memory), a PROM (Programmable ROM), an EPROM (Electrically Programmable ROM), an EEPROM (Electrically Erasable and Programmable ROM), a flash memory device, a PRAM (Phase-change RAM), an MRAM (Magnetic RAM), an RRAM (Resistive RAM), an FRAM (Ferroelectric RAM), etc.

A flash memory device may have data processing characteristics different from those of a conventional HDD or a semiconductor memory device. For example, a flash memory device may not support in-place updates on previously written data.

### SUMMARY

Exemplary embodiments of the present inventive concept provide a nonvolatile memory device which is provided with write requested data and category information of the write requested data from a host. The nonvolatile memory device includes a memory onto which a flash translation layer is loaded, a controller adapted to execute the flash translation layer loaded onto the memory, and a nonvolatile memory including a first memory area and a second memory area. The flash translation layer refers to the category information to map a logical address of the write requested data to a physical address such that the write requested data is stored in one of the first and second memory areas. The category information is determined based on a storage characteristic, including a logical address allocation manner, of the write requested data.

The storage characteristic may include an update frequency and a life cycle of the write requested data.

Categories into which the write requested data is classified may include a first category including files having a life cycle shorter than a predetermined time, and a second category including files having an update frequency higher than a predetermined frequency. When the write requested data is classified into the first category based on the category information, the flash translation layer maps a logical address of the write requested data to a physical address so as to be stored in the first memory area. When the write requested data is classified into the second category based on the category information, the flash translation layer maps a logical address of the write requested data to a physical address so as to be stored in the second memory area.

The first category may include a temporary file.

The second category may include database files and metadata.

In exemplary embodiments, the nonvolatile memory further includes a third memory area, and the categories into which the write requested data is classified may further include a third category including files having logical addresses which are allocated in a round-robin manner. When the write requested data is classified into the third category based on the category information, the flash translation layer maps a logical address of the write requested data to a physical address so as to be stored in the third memory area.

The third category may include a journal file of a file system.

Exemplary embodiments of the present inventive concept provide an electronic device connected to a nonvolatile memory device. The electronic device includes a category classifying driver adapted to classify write requested data into predetermined categories based on a storage characteristic of data to be stored in the nonvolatile memory device, and to provide classified category information to the nonvolatile memory device together with the write requested data. The electronic device further includes a memory adapted to store the category classifying driver, and a controller adapted to execute the category classifying driver. The category classifying driver predetermines a plurality of categories, and at least one of the plurality of categories includes a file having a logical address which is allocated in a round-robin manner.

The categories may include a first category including files having a life cycle shorter than a predetermined time, a second category including files having an update frequency higher than a predetermined frequency, and a third category including files having logical addresses which are allocated in a round-robin manner.

The second category may include database files and metadata, and the third category may include a journal file of a file system.

The category classifying driver may classify the write requested data into the predetermined categories based on journal block information of the file system.

The first category may include a temporary file.

The category classifying driver may classify the write requested data into the predetermined categories based on an index node of an operating system.

The category classifying driver may identify a file name and a parent directory of the write requested data using the index node, and may classify the write requested data into the predetermined categories based on the identified file name and parent directory.

The electronic device may exchange information with the nonvolatile memory device using an eMMC interface standard, and the category information may be provided to the nonvolatile memory device using a context ID according to the eMMC interface standard.

Exemplary embodiments of the present inventive concept provide a nonvolatile memory device including a flash translation layer, a controller, and first and second memory areas. The controller is configured to execute the flash translation layer. The nonvolatile memory is configured to receive write requested data and corresponding category information. The flash translation layer is configured to map a logical address of the write requested data to a physical address, based on the category information, such that the write requested data is selectively stored in one of the first and second memory areas. The category information is based on a storage characteristic of the write requested data.

Exemplary embodiments of the present inventive concept provide an electronic device connected to a nonvolatile memory device including a category classifying driver, a memory, and a controller. The category classifying driver is configured to classify write requested data to be stored in the nonvolatile memory device into predetermined categories based on a storage characteristic of the write requested data, and to provide the write requested data and classified category information to the nonvolatile memory device. The memory is configured to store the category classifying driver. The controller is configured to execute the category classifying driver. At least one of the plurality of categories corresponds to files having logical addresses allocated in a round-robin manner.

Exemplary embodiments of the present inventive concept provide a solid state drive (SSD) system including a host and an SSD. The host includes a host interface, a host controller, and a main memory. The SSD includes a flash translation layer, a SSD controller configured to execute the flash translation layer, and a plurality of nonvolatile memories. The SSD is configured to receive write requested data and corresponding category information from the host via the host controller. The flash translation layer is configured to map a logical address of the write requested data to a physical address, based on the category information, such that the write requested data is selectively stored in one of the plurality of nonvolatile memories. The category information is based on a storage characteristic of the write requested data.

### BRIEF DESCRIPTION OF THE DRAWINGS

The above and other features of the present inventive concept will become more apparent by describing in detail exemplary embodiments thereof with reference to the accompanying drawings, in which:

FIG. 1 is a block diagram illustrating a computing system, according to an exemplary embodiment of the present inventive concept.

FIG. 2 is a diagram illustrating a data write operation being performed in a nonvolatile memory device, according to an exemplary embodiment of the present inventive concept.

FIG. 3 shows data write distribution according to various types of data requested to be written during execution of various applications, according to an exemplary embodiment of the present inventive concept.

FIG. 4 is a graph illustrating a storage characteristic of journal data, according to an exemplary embodiment of the present inventive concept.

FIG. 5 is a graph illustrating a storage characteristic of metadata, according to an exemplary embodiment of the present inventive concept.

FIG. 6 is a diagram illustrating software layers of the computing system of FIG. 1, according to an exemplary embodiment of the present inventive concept.

FIG. 7 is a diagram illustrating a data classifying operation, according to an exemplary embodiment of the present inventive concept.

FIG. 8 is a diagram illustrating a flash translation layer of FIG. 6, according to an exemplary embodiment of the present inventive concept.

FIG. 9 is a diagram illustrating a data storing operation of a nonvolatile memory device, according to an exemplary embodiment of the present inventive concept.

FIGS. 10 to 12 are graphs showing the results of various applications executed using a flash translation layer, according to an exemplary embodiment of the present inventive concept.

FIG. 13 is a flowchart illustrating a data processing method of a nonvolatile memory device, according to an exemplary embodiment of the preset inventive concept.

FIG. 14 is a block diagram illustrating a solid state drive system to which a computing system according to an exemplary embodiment of the present inventive concept is applied.

FIG. 15 is a block diagram illustrating a memory card to which a nonvolatile memory device according to an exemplary embodiment of the present inventive concept is applied.

FIG. 16 is a diagram illustrating various systems to which the memory card in FIG. 15 may be applied, according to exemplary embodiments of the present inventive concept.

### DETAILED DESCRIPTION OF THE EXEMPLARY EMBODIMENTS

Exemplary embodiments of the present inventive concept will be more fully described with reference to the accompanying drawings. Like reference numerals may refer to like elements throughout the accompanying drawings.

It will be understood that, although the terms “first”, “second”, “third”, etc., may be used herein to describe various elements, components, regions, layers and/or sections. These elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section.

Spatially relative terms, such as “beneath”, “below”, “lower”, “under”, “above”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” or “under” other elements or features would then be oriented “above” the other elements or features. Thus, the exemplary terms “below” and “under” can encompass both an orientation of above and below. The device may be otherwise oriented (rotated 90 degrees or at other orientations) and the spatially relative descriptors used herein interpreted accordingly. In addition, it will also be understood that when a layer is referred to as being “between” two layers, it can be the only layer between the two layers, or one or more intervening layers may also be present.

It will be understood that when an element or layer is referred to as being “on”, “connected to”, “coupled to”, or “adjacent to” another element or layer, it can be directly on, connected, coupled, or adjacent to the other element or layer, or intervening elements or layers may be present.

FIG. 1 is a block diagram illustrating a computing system 1, according to an exemplary embodiment of the present inventive concept. Referring to FIG. 1, a computing system 1 may include a host 10 and a nonvolatile memory device 20.

The computing system 1 may classify data into predetermined categories based on characteristics of the data, and/or the locality of data. The nonvolatile memory device 20 may include, for example, a plurality of physical areas respectively corresponding to the predetermined categories. The computing system 1 may store data in a corresponding area of the nonvolatile memory device 20 based on the classified categories.

The computing system 1 may reduce a garbage collection operation by physically classifying a space in which data is stored according to the locality of data. As a result, the number of garbage collection operations used to process data may be reduced, and the speed and efficiency of the computing system 1 may be improved (e.g., as the result of implementing less erase operations).

The host 10 may include a processor 11 and a main memory 12, and may access the nonvolatile memory device 20. The host 10 may store data generated in response to the execution of a predetermined operation in the nonvolatile memory device 20, or the host 10 may perform a predetermined operation based on data stored in the nonvolatile memory device 20.

The processor 11 may control an overall operation of the host 10. For example, the processor 11 may drive a variety of software such as an operating system, an application, etc. Further, the processor 11 may drive a variety of firmware to control the computing system 1. The host 10 may access the nonvolatile memory device 20 under the control of software or firmware driven by the processor 11. The main memory 12 may provide a storage area in which software or firmware is driven. The main memory 12 may be, for example, RAM, however the main memory 12 is not limited thereto.

The nonvolatile memory device 20 may store various types of data processed by the host 10. The nonvolatile memory device 20 may include a controller 21 and a plurality of nonvolatile memories 22_1 to 22_{—}n. The plurality of nonvolatile memories 22_1 to 22_{—}n may be referred to herein as first, second, third, etc. memory areas of the nonvolatile memory device 20.

The controller 21 may access the nonvolatile memories 22_1 to 22_{—}n in response to a request of the host 10. For example, the controller 21 may control read, write and erase operations of the nonvolatile memories 22_1 to 22_{—}n in response to a request of the host 10.

The controller 21 may provide an interface between the nonvolatile memories 22_1 to 22_{—}n and the host 10, may drive firmware to control the nonvolatile memories 22_1 to 22_{—}n, and may include a controller processor 21a and a controller memory 21b.

The controller processor 21a may control an overall operation of the controller 21. For example, the controller processor 21a may drive firmware to control the nonvolatile memories 22_1 to 22_{—}n. The controller memory 21b may act as a working memory of the controller 21, a buffer memory between the host 10 and the nonvolatile memories 22_1 to 22_{—}n, or a cache memory of the nonvolatile memories 22_1 to 22_{—}n.

The nonvolatile memories 22_1 to 22_{—}n may store data under the control of the controller 21. The nonvolatile memories 22_1 to 22_{—}n may be any one of, or any combination of for example, a ROM (Read Only Memory), a PROM (Programmable ROM), an EPROM (Electrically Programmable ROM), an EEPROM (Electrically Erasable and Programmable ROM), a flash memory, a PRAM (Phase-change RAM), an MRAM (Magnetic RAM), an RRAM (Resistive RAM), an FRAM (Ferroelectric RAM), etc.

Data exchange between the host 10 and the controller 21 may be made based on at least one of various interface protocols such as, for example, a universal serial bus (USB) protocol, a multimedia card (MMC) protocol, a peripheral component interconnection (PCI) protocol, a PCI-express (PCI-E) protocol, an advanced technology attachment (ATA) protocol, a serial-ATA protocol, a parallel-ATA protocol, a small computer small interface (SCSI) protocol, an enhanced small disk interface (ESDI) protocol, and an integrated drive electronics (IDE) protocol.

When a write request is generated, the host 10 may transfer write requested data and a logical address LA to the nonvolatile memory device 20. The nonvolatile memory device 20 may store data in the nonvolatile memories 22_1 to 22_{—}n in response to a request of the host 10.

Data writing and reading operations of the nonvolatile memory device 20 may be performed by a page unit, and an erase operation may be performed a block unit.

In the nonvolatile memory device 20, the controller 21 may provide an interface to provide compatibility between the host 11 to process data by a sector unit and the nonvolatile memory device 20 to process data by page and block units.

The controller 21 may include a flash translation layer (FTL). When a data writing operation is requested, the FTL may map logical addresses LA provided from the host 10 to physical addresses PA of the nonvolatile memories 22_1 to 22_{—}n.

The FTL may provide an interface for hiding an erase operation on the nonvolatile memories 22_1 to 22_{—}n between the nonvolatile memories 22_1 to 22_{—}n and a file system of the host 10, using the above-described mapping operation. In exemplary embodiments, referring to the nonvolatile memories 22_1 to 22_{—}n, the FTL may compensate for an erase-before-write operation and a mismatch between an erase unit and a write unit, as described further with reference to FIGS. 5 to 7.

Data storage characteristics may vary according to the locality of write requested data. The data storage characteristic may include, for example, a data update frequency, an erase frequency, characteristics of allocated logical addresses, etc. For example, the storage characteristic may correspond to a logical address allocation manner (e.g., round-robin) of the data. The computing system 1 may classify and manage an area in which data is to be written in response to the locality of data. As a result, the data processing performance, including, for example, the write performance of the computing system 1, may be improved.

FIG. 2 is a diagram illustrating a data write operation being performed in a nonvolatile memory device, according to an exemplary embodiment of the present inventive concept. Nonvolatile memories 22_1 to 22_{—}n of the nonvolatile memory device 20 (refer to FIG. 1) may include a first physical block PB1 and a second physical block PB2, each configured to store data. In exemplary embodiments, a physical block may include four pages, as shown in FIG. 2. However, the number of pages included in each physical block is not limited thereto.

As described with reference to FIG. 1, when a data writing operation is requested by the host 10, the nonvolatile memory device 20 may map a logical address of data to a physical address. The nonvolatile memory device 20 may write data to a physical block corresponding to the physical address mapped.

Referring to FIG. 2, in operation (I), write operations on first and second data A and B may be requested. The nonvolatile memory device 20 may write the first data A and the second data B to an area corresponding to the physical block mapped (e.g., the first physical block PB1). The first data A and the second data B may be sequentially stored in pages of the first physical block PB1.

In operation (II), the host 10 may request an update operation of changing the second data B with third data B 1, and a write operation on fourth data C. The nonvolatile memory device 20 may write the third data B1 and the fourth data C to the remaining pages of the first physical block PB1 and invalidate the second data B.

In operation (III), the host 10 may request an update operation of changing the third data B1 with fifth data B2. The nonvolatile memory device 20 may check whether an empty page exists in the first physical block PB1. If an empty page does not exist in the first physical block PB1, the second physical block PB2 may be allocated as a new physical block.

Once PB2 has been allocated, the nonvolatile memory device 20 may copy valid data of the first physical block PB1 to pages of the second physical block PB2. The valid data may refer to, for example, the most recent unchanged data. The nonvolatile memory device 20 may write the fifth data B2 to an empty page of the second physical block PB2 and invalidate all data of the first physical block PB1.

In operation (IV), since the first physical block PB1 is an invalid block including only invalid data, the nonvolatile memory device 20 may erase the first physical block PB1.

As described with reference to operations (I) to (IV), a number of copy and erase operations may be required when data stored in the nonvolatile memory device 20 is frequently erased or updated. In exemplary embodiments, although storage characteristics of the first data A and the fourth data C may be different from a storage characteristic of the second data B, the first data A and the fourth data C may be copied together with the second data B through an update operation. The nonvolatile memory device 20 may classify data in response to the storage characteristic and may perform a data storing operation based on the classification result.

FIG. 3 shows data write distribution according to various types of data requested to be written during execution of various applications, according to an exemplary embodiment of the present inventive concept. Exemplary applications may include, for example, YOUTUBE, a browser, FACEBOOK, etc. Types of data may be classified as, for example, metadata, journal data, database (DB) data, temporary database (DB-Temp) data, cache data, XML (eXtensible Markup Language) data, etc.

Referring to FIG. 3, data writing operations may be variously requested according to different types of data. For example, a write request relating to journal data may be frequently generated. As a result, the journal data may be a type of data predicted as having a high update frequency.

FIG. 4 is a graph illustrating a storage characteristic of journal data, according to an exemplary embodiment of the present inventive concept. In FIG. 4, a horizontal axis may indicate a write request index, and a vertical axis may indicate a logical address allocated to journal data at a write request.

Referring to FIG. 4, a logical address of the journal data may be allocated linearly and iteratively within a specific logical address section in response to a write request. This may be the result of the journal data having a storage characteristic such that it is overwritten in a round-robin pattern within the specific logical address section. Thus, if the journal data is managed independently from other data, all pages of a physical block in which the journal data is stored may be sequentially invalidated. As a result, unnecessary copy and garbage collection operations may be avoided.

FIG. 5 is a graph illustrating a storage characteristic of metadata, according to an exemplary embodiment of the present inventive concept. In FIG. 5, a horizontal axis may indicate a write request index, and a vertical axis may indicate a logical address allocated to metadata at a write request.

Referring to FIG. 5, a logical address of the metadata may be iteratively allocated within a specific logical address section in response to a write request. In a logical address allocated to the metadata, both spatial locality and temporal locality may be high. This may be the result of a specific logical address space being allocated to the metadata, and the erase and generation frequencies of the metadata being high. Thus, if the metadata is managed independently from other data, all pages of a physical block in which the metadata is stored may be invalidated within a short time. As a result, unnecessary copy and garbage collection operations may be avoided.

As described with reference to FIGS. 4 and 5, a storage characteristic of data may vary depending on the types of data. That is, different types of data may have different storage characteristics. According to exemplary embodiments of the present inventive concept, a computing system may classify data into a specific category, and manage an area in which data is stored independently based on the type of category. As a result, the efficiency of processing data may be improved.

FIG. 6 is a diagram illustrating software layers of the computing system 1 of FIG. 1, according to an exemplary embodiment of the present inventive concept. Referring to FIGS. 1 and 6, a computing system 1 may include an application 110, a file system 120, a category classifying driver 130, a flash translation layer 140, and a nonvolatile memory (e.g., a flash memory) 150. The nonvolatile memory 150 may correspond to the plurality of nonvolatile memories 22_1 to 22_N of FIG. 1.

The computing system 1 may classify data into a predetermined category according to a storage characteristic of the data. Each category may have a corresponding ID. The computing system 1 may store data in a physical area allocated to each ID.

The application 110 may refer to a variety of application programs driven on the computing system 1. For example, the application 110 may include a document editor, a spreadsheet, database, an internet browser, a voice player, or a video player driven on the computing system 1. However, the application 110 is not limited thereto.

The application 110 may be driven by the processor 11 of the host 10.

The file system 120 may manage the storage space of the nonvolatile memory device 20 and data stored therein. For example, the application 110 may access data stored in the nonvolatile memory device 20 through the file system 120. The file system 120 may be, for example, a FAT, FAT32, NTFS, HFS, JSF2, XFS, ODS-5, UDF, ZFS, UFS (Unix File System), ext2, ext3, ext4, ReiserFS, Reiser4, ISO 9660, Gnome VFS, BFS, or WinFS file system. However, the file system 120 is not limited thereto. The file system 120 may be driven by the processor 11 of the host 10.

When a data writing operation is requested, the category classifying driver 130 may classify data into a predetermined category. Data may be classified according to the locality of the data and/or a storage characteristic of the data. When data is transferred from the host 10 to the nonvolatile memory device 20, the category classifying driver 130 may transfer the ID corresponding to the category of data with the data.

The flash translation layer 140 may provide an interface between the file system 120 and the nonvolatile memory 150. For example, the flash translation layer 140 may perform a mapping operation between logical addresses of the file system 120 and physical addresses of the nonvolatile memory 150. For example, when a write request is generated, the flash translation layer 140 may allocate a physical address of an area corresponding to the ID generated by the category classifying driver 130 to the data.

The flash translation layer 140 may control a background operation of the nonvolatile memory device 20. For example, the flash translation layer 140 may control merge, garbage collection and wear-leveling operations of the nonvolatile memory device 20. In exemplary embodiments, the flash translation layer 140 may be replaced with a host driver corresponding to a nonvolatile memory used in the computing system 1.

The flash translation layer 140 may be driven by the controller processor 21a of the controller 21. The flash translation layer 140 may be stored in the nonvolatile memory 150. The controller 21 may read the flash translation layer 140 from the nonvolatile memory 150 and drive the flash translation layer 140. Alternatively, the controller 21 may further include a nonvolatile memory storing the flash translation layer 140.

FIG. 7 is a diagram illustrating a data classifying operation, according to an exemplary embodiment of the present inventive concept. Referring to FIG. 7, an operating system software layer may include an application 110, a file system 120, and a category classifying driver 130.

In the event that a file is changed or generated during execution of the application 110, the application 110 may request a file writing operation. The application 110 may provide the file system 120 with information relating to the write requested file.

The file system 120 may provide data of the write requested file and a logical address LA with a write command CMD.

The category classifying driver 130 may classify the write requested file into a predetermined category based on a storage characteristic and/or locality. The category classifying driver 130 may add an ID corresponding to a category to the write command CMD, data of the file and the logical address LA provided from the file system 120 to provide the resultant data to the flash translation layer 140 (refer to FIG. 6). In exemplary embodiments, the category classifying driver 130 may classify files into four categories, however the number of categories is not limited thereto.

In an example, the first category may include files having a short life cycle (e.g., a high generation and deletion frequency). Whether a life cycle of a file is short may be determined by comparing the life cycle of the file with a predetermined life cycle. The first category may include, for example, a temporary file.

In exemplary embodiments, the probability that files classified into the first category are invalidated in a short period may be high. For example, since temporary files are deleted if a constant period when a temporary file is kept elapses, the probability of invalidation may be high. A physical block in which files classified into the first category are stored may be invalidated in a short period. Thus, it may be efficient to erase a block without a copy operation on remaining valid pages.

In the current example, the second category may include files having a high update frequency. Whether an update frequency is high may be determined by comparing the update frequency with a predetermined update frequency. The second category may include, for example, database files and metadata.

Since files classified into the second category are continuously write requested, the probability that previously written data is invalidated may be high. For example, the probability of invalidation on files classified into the second category may be lower than that of files classified into the first category. A physical block in which files classified into the second category are stored may be invalidated in a short period.

Thus, it may be efficient to erase a block without a copy operation on remaining valid pages.

In the current example, the third category may include files having logical addresses which are allocated in a round-robin manner. The third category may include, for example, journal data.

In the current example, since files classified into the third category are sequentially overwritten, a physical block in which files classified into the third category are stored may be sequentially invalidated. Since a physical block in which files classified into the second category are stored becomes an invalid block in response to a lapse of time, it may be efficient to erase a block without a copy operation on remaining valid pages.

In the current example, files classified into the fourth category may include files which are not classified into the first to third categories. Files classified into the fourth category may be managed in the same manner as general data.

In the example described above, the category classifying driver 130 classifies files into four categories. However, exemplary embodiments are not limited to four categories, and are not limited to the types of data classified into the four categories as described above. For example, the category classifying driver 130 may classify database files and metadata into different categories, may classify files into three categories or less or five categories or more, etc.

The category classifying driver 130 may refer to an index node (which may be referred to herein as an Inode) of an operating system to classify files. The category classifying driver 130 may extract a name and a parent directory of a write requested file based on the index node of the operating system. The category classifying driver 130 may classify files based on names and parent directories of the files. For example, since a file stored in a cache or database directory, or having a name including “db-”, refers to a temporary file, the file may be classified into the first category.

The category classifying driver 130 may refer to journal block information at a file system to classify files. The category classifying driver 130 may classify journal data based on the journal block information. However, a file classifying method of the category classifying driver 130 is not limited thereto.

The category classifying driver 130 may allocate corresponding IDs to respective categories. For example, an nth ID may be allocated to an nth category.

When write data is transferred to the flash translation layer 140, the category classifying driver 130 may send a corresponding ID together with the write data.

Since the ID is additionally transferred information, an additional interface may be used to transfer the ID from the host 10 to the nonvolatile memory device 20. Alternatively, in an exemplary embodiment, the nonvolatile memory device 20 may use an interface (e.g., an embedded multimedia card (eMMC) 4.5) that allows additional information to be transferred, and thus, the ID may be transferred without an additional interface. For example, the host 10 may allocate ContextID provided from the eMMC 4.5 to an ID area.

FIG. 8 is a diagram illustrating a hierarchy of the flash translation layer 140 of FIG. 6, according to an exemplary embodiment of the present inventive concept. Referring to FIG. 8, the flash translation layer 140 may include a file system interface 141, an ID classifier 142, a data mapper 143, a bad block manager 144, an error corrector 145, and a nonvolatile memory interface 146 (e.g., a flash memory interface).

The file system interface 141 may provide an interface between the flash translation layer 140 and the file system 120 (refer to FIG. 6).

If a write request is generated, the ID classifier 142 may recognize an ID provided with data. The data mapper 143 may map data to a corresponding physical address in response to the ID recognized by the ID classifier 142.

In the event that an original physical block in which data is stored does not include an empty page, and in which invalid pages exist in the original physical block, the data mapper 143 may allocate a new physical block. The data mapper 143 may copy invalid pages in the original physical block to the newly allocated physical block, and map empty pages of the newly allocated physical block to physical addresses. After copying invalid pages stored in the original physical block, the data mapper 143 may erase the original physical block.

In the event that an original physical block in which data is stored does not include an empty page, and all pages of the original physical block are valid pages, the data mapper 143 may allocate a new physical block and map empty pages of the newly allocated physical block to physical addresses. That is, the data mapper 143 may provide physical addresses of empty pages capable of writing data.

If a physical block corresponding to a physical address mapped by the data mapper 143 includes a bad block, the bad block manager 144 may translate the physical address mapped to a physical address of a new physical block not including a bad block. The bad block manager 144 may be configured to use the remaining pages in a physical block other than pages in the physical block including a bad block.

When an application writes data, the error corrector 145 may add an error correction code ECC to the data. The error corrector 145 may subsequently correct an error generated at a read operation.

The nonvolatile memory interface 146 may provide an interface between the flash translation layer 140 and the nonvolatile memory 150 (refer to FIG. 6).

Referring to FIGS. 1 and 8, according to exemplary embodiments, the flash translation layer 140 may store data in a corresponding area of the nonvolatile memory device 20 in response to a classified category. The computing system 1 may reduce a garbage collection operation by classifying a data storage space physically according to the locality of data using the flash translation layer 140. Since a garbage collection operation used to process data may be reduced, less erase operations may be implemented by the computing system 1 when processing data, and thus, the processing speed of the computing system 1 may be improved.

FIG. 9 is a diagram illustrating a data storing operation of a nonvolatile memory device, according to an exemplary embodiment of the present inventive concept. In exemplary embodiments, an ID may be transferred from the host 10 (refer to FIG. 1) in a ContextID form. If a write request on data is generated, the nonvolatile memory device 20 may identify the ID provided with the data.

As described above, the nonvolatile memory device 20 may include a plurality of nonvolatile memories 22_1 to 22_{—}n. The nonvolatile memories 22_1 to 22_{—}n may include, for example, first to fifth areas AREA1 to AREA5, each of which includes a plurality of physical blocks. Each area may correspond to an ID. For example, the first area AREA1 may correspond to ID0. Exemplary embodiments are not limited to five areas and five corresponding IDs. For example, exemplary embodiments may include four or less areas and corresponding IDs, or six or more areas and corresponding IDs. Further, the types of data, and the association of IDs and areas, are not limited to those shown in FIG. 9.

The nonvolatile memory device 20 may store provided data in an allocated area based on the ID. For example, the nonvolatile memory device 20 may map a physical address of data having ID1 to an area included in the second area AREA2, and store the data in the second area AREA2.

According to exemplary embodiments, the nonvolatile memory device 20 may reduce a garbage collection operation by classifying a data storage space physically according to the locality of data. Since a garbage collection operation used to process data may be reduced, less erase operations may be performed by the nonvolatile memory device 20, and thus, speed and performance of the memory device 20 may be improved.

FIGS. 10 to 12 are graphs showing the results of various applications executed using a flash translation layer, according to an exemplary embodiment of the present inventive concept.

FIG. 10 is a graph showing the number of zero cost blocks generated when applications are executed using a conventional flash translation layer HC-FTL, and a flash translation layer according to an exemplary embodiment of the present inventive concept. A zero cost block may refer to, for example, a block that is erasable without a copy operation. For example, an invalid block in which all pages are invalid may be a zero cost block. According to exemplary embodiments, the number of copy operations performed may decrease in proportion to an increase in the number of zero cost blocks. Thus, efficiency may be improved.

FIG. 11 is a graph showing an amount of time required to execute a flash translation layer when applications are executed using a conventional flash translation layer HC-FTL, and a flash translation layer according to an exemplary embodiment of the present inventive concept. As shown in FIG. 11, the number of garbage collection operations may be reduced by applying a flash translation layer according to exemplary embodiments of the present inventive concept. Thus, an execution time may be improved.

FIG. 12 is a graph showing the number of erase operations on a physical block when applications are executed using a conventional flash translation layer HC-FTL, and a flash translation layer according to an exemplary embodiment of the present inventive concept. When a flash translation layer according to an exemplary embodiment of the present inventive concept is applied, invalid pages may be intensively collected in a specific physical block. Thus, the number of garbage collection operations, and/or the number of erase operations, may be reduced, thereby improving performance.

FIG. 13 is a flowchart illustrating a data processing method of a nonvolatile memory device, according to an exemplary embodiment of the present inventive concept.

In operation S110, a write request is provided from a host. For example, the host may provide a nonvolatile memory device with a write command, file data of write requested data, a logical address, and an ID corresponding to a category.

In operation S120, a category of the write requested data may be recognized using the ID. Data may be classified into a predetermined category according to the locality and/or storage characteristic of the data. For example, the data may be classified into a first category including files having a high generation and deletion frequency (e.g., a short life cycle), a second category including files having a high update frequency, a third category including files having logical addresses which are allocated in a round-robin manner, and a fourth category including remaining files not classified into the first to third categories.

In operation 5130, a logical address of the provided data may be mapped to a physical address of a physical area allocated to each category based on a category of data recognized. For example, the nonvolatile memory device may include first to fourth areas respectively corresponding to the first to fourth categories. A flash translation layer of the nonvolatile memory device may perform a mapping operation such that data is stored in an area corresponding to the category.

In operation S140, data may be written to the allocated area based on the mapping result of operation S130.

The nonvolatile memory device according to an exemplary embodiment of the present inventive concept may classify and manage a data storing area according to classified categories based on a storage characteristic of data, thereby improving data processing efficiency.

FIG. 14 is a block diagram illustrating a solid state drive system to which a computing system according to an exemplary embodiment of the present inventive concept is applied. Referring to FIG. 14, a solid state drive (SSD) system 1000 may include a host 1100 and an SSD 1200. The host 1100 may include a host interface 1121, a host controller 1120, and a DRAM 1130.

The host 1100 may write data to the SSD 1200 or read data from the SSD 1200. The host controller 1120 may transfer signals such as, for example, a command signal, an address signal, a control signal, an ID signal indicating a category of a file, etc., to the SSD 1200 through the host interface 1121. The DRAM 1130 may function as a main memory of the host 1100.

The SSD 1200 may exchange signals with the host 1100 through a host interface 1211, and may be supplied with power through a power connector 1221. The SSD may receive power via the host 1100, as shown in FIG. 14, or via another entity. The SSD 1200 may include a plurality of nonvolatile memories 1201 to 120n, an SSD controller 1210, and an auxiliary power supply 1220. The nonvolatile memories 1201 to 120n may be implemented using, for example, NAND flash memory, as well as other types of nonvolatile memories such as, for example, PRAM, MRAM, ReRAM, etc.

The plurality of nonvolatile memories 1201 to 120n may be used as a storage medium of the SSD 1200. The plurality of nonvolatile memories 1201 to 120n may be connected to the SSD controller 1210 through a plurality of channels CH1 to CHn. One channel may be connected with one or more nonvolatile memories. Nonvolatile memories connected to one channel may be connected to the same data bus.

The SSD controller 1210 may exchange signals with the host 1100 through the host interface 1211. The signals may include, for example, a command signal, an address signal, a control signal, an ID signal indicating a category of a file, etc.

The SSD controller 1210 may be configured to write or read data to or from a corresponding nonvolatile memory according to a command of the host 1100.

The auxiliary power supply 1220 may be connected to the host 1100 (or to another power supplying entity) through the power connector 1221. The auxiliary power supply 1220 may be charged using power from the host 1100. The auxiliary power supply 1220 may be located inside or outside the SSD 1200. For example, the auxiliary power supply 1220 may be included on a main board of the SSD 1200, and may supply auxiliary power to the SSD 1200.

The SSD system 1000 may reduce a number of garbage collection operations performed by classifying a data storage space physically according to locality of data. Since a number of garbage collection operations used to process data may be reduced, the SSD system 1000 may process data with less erase operations, and thus, speed of the SSD system 1000 may be improved.

FIG. 15 is a block diagram illustrating a memory card to which a nonvolatile memory device according to an exemplary embodiment of the present inventive concept is applied. A memory card 2000 may be, for example, an MMC card, an SD card, a multiuse card, a micro-SD card, a memory stick, a compact SD card, an ID card, a PCMCIA card, an SSD card, a chip-card, a smartcard, a USB card, etc.

Referring to FIG. 15, the memory card 2000 may include an interface circuit 2100 for interfacing with an external device, a controller 2200, including a buffer memory, which controls an operation of the memory card 2000, and at least one nonvolatile memory device 2300 according to an exemplary embodiment of the present inventive concept. The controller 2200 may be, for example, a processor configured to control write and read operations of the nonvolatile memory device 2300. The controller 2200 may be connected to the nonvolatile memory device 2300 and the interface circuit 2100 through a data bus and an address bus.

The interface circuit 2100 may be provided with an ID corresponding to a category of data from an external device at a write request. The controller 2200 may use a flash translation layer, and may classify and manage an area in which data is written, based on the category of data. Thus, the data processing performance (e.g., the write performance) of the memory card 2000 may be improved.

FIG. 16 is a diagram illustrating various systems to which the memory card 2000 in FIG. 15 may be applied, according to exemplary embodiments of the present inventive concept. Referring to FIG. 16, the memory card 2000 may be applied to, for example, a video camera (I), a television (II), an audio device (III), a game machine (IV), an electronic music device (V), a cellular phone (VI), a computer (VII), a Personal Digital Assistant (VIII), a voice recorder (IX), a PC card (X), etc.

A nonvolatile memory device according to exemplary embodiments of the present inventive concept may be packaged using various types of packages. For example, a non-volatile memory device or a memory controller according to exemplary embodiments of the present inventive concept may be packaged using, for example, PoP (Package on Package), Ball grid arrays (BGAs), Chip scale packages (CSPs), Plastic Leaded Chip Carrier (PLCC), Plastic Dual In-Line Package (PDIP), Die in Waffle Pack, Die in Wafer Form, Chip On Board (COB), Ceramic Dual In-Line Package (CERDIP), Plastic Metric Quad Flat Pack (MQFP), Small Outline (SOIC), Shrink Small Outline Package (SSOP), Thin Small Outline (TSOP), Thin Quad Flatpack (TQFP), System In Package (SIP), Multi Chip Package (MCP), Wafer-level Fabricated Package (WFP), Wafer-Level Processed Stack Package (WSP), etc.

Exemplary embodiments of the present inventive concept may be modified according to different uses. For example, the detailed structure of a host, a nonvolatile memory device, and/or a controller may be changed or modified variously according to different uses.

While the present inventive concept has been described with reference to the exemplary embodiments thereof, it will be understood by those of ordinary skill in the art that various changes and modifications may be made without departing from the spirit and scope of the present inventive concept as defined by the following claims.

What is claimed is:

1. A nonvolatile memory device, comprising:
a memory onto which a flash translation layer is loaded;
a controller configured to execute the flash translation layer loaded onto the memory; and
a first memory area and a second memory area,
wherein the nonvolatile memory device is configured to receive write requested data and corresponding category information,
wherein the flash translation layer is configured to map a logical address of the write requested data to a physical address, based on the category information, such that the write requested data is selectively stored in one of the first and second memory areas,
wherein the category information is based on a storage characteristic of the write requested data.

2. The nonvolatile memory device of claim 1, wherein the storage characteristic of the write requested data corresponds to a logical address allocation manner of the write requested data.

3. The nonvolatile memory device of claim 1, wherein the category information is further based on a locality of the write requested data.

4. The nonvolatile memory device of claim 1, wherein the storage characteristic of the write requested data comprises an update frequency of the write requested data and a life cycle of the write requested data.

5. The nonvolatile memory device of claim 4, wherein the category information refers to a first category corresponding to files having a life cycle shorter than a predetermined time, and a second category corresponding to files having an update frequency higher than a predetermined frequency,
wherein the flash translation layer is configured to map the logical address of the write requested data to the physical address such that the write requested data is selectively stored in the first memory area when the write requested data is classified as belonging to the first category based on the category information,
wherein the flash translation layer is configured to map the logical address of the write requested data to the physical address such that the write requested data is selectively stored in the second memory area when the write requested data is classified as belonging to the second category based on the category information.

6. The nonvolatile memory device of claim 5, wherein the first category corresponds to temporary files.

7. The nonvolatile memory device of claim 5, wherein the second category corresponds to database files and metadata.

8. The nonvolatile memory device of claim 5, wherein the nonvolatile memory device further comprises a third memory area,
wherein the category information further refers to a third category corresponding to files having logical addresses allocated in a round-robin manner,
wherein the flash translation layer is configured to map the logical address of the write requested data to the physical address such that the write requested data is selectively stored in the third memory area when the write requested data is classified as belonging to the third category based on the category information.

9. The nonvolatile memory device of claim 8, wherein the third category corresponds to journal files of a file system.

10. The nonvolatile memory device of claim 1, wherein the memory on which the flash translation layer is loaded is disposed in the controller.

11. An electronic device connected to a nonvolatile memory device, comprising:
a category classifying driver configured to classify write requested data to be stored in the nonvolatile memory device into predetermined categories based on a storage characteristic of the write requested data, and to provide the write requested data and classified category information to the nonvolatile memory device;
a memory configured to store the category classifying driver; and
a controller configured to execute the category classifying driver,
wherein at least one of the plurality of categories corresponds to files having logical addresses allocated in a round-robin manner.

12. The electronic device of claim 11, wherein the predetermined categories comprise:
a first category corresponding to files having a life cycle shorter than a predetermined time;
a second category corresponding to files having an update frequency higher than a predetermined frequency; and
a third category corresponding to the files having logical addresses allocated in a round-robin manner.

13. The electronic device of claim 12, wherein the second category corresponds to database files and metadata, and the third category corresponds to journal files of a file system.

14. The electronic device of claim 13, wherein the category classifying driver is configured to classify the write requested data into the predetermined categories based on journal block information of the file system.

15. The electronic device of claim 12, wherein the first category corresponds to temporary files.

16. The electronic device of claim 12, wherein the category classifying driver is configured to classify the write requested data into the predetermined categories based on an index node of an operating system.

17. The electronic device of claim 16, wherein the category classifying driver is configured to identify a file name and a parent directory of the write requested data using the index node, and classify the write requested data into the predetermined categories based on the file name and the parent directory.

18. The electronic device of claim 12, wherein the electronic device is configured to exchange information with the nonvolatile memory device using an embedded multimedia card (eMMC) interface standard, and the category information is provided to the nonvolatile memory device using a context ID according to the eMMC interface standard.

19. A solid state drive (SSD) system, comprising:
a host comprising a host interface, a host controller, and a main memory; and
a SSD comprising a SSD controller configured to execute a flash translation layer, and a plurality of nonvolatile memories,
wherein the SSD is configured to receive write requested data and corresponding category information from the host via the host controller,
wherein the flash translation layer is configured to map a logical address of the write requested data to a physical address, based on the category information, such that the write requested data is selectively stored in one of the plurality of nonvolatile memories,
wherein the category information is based on a storage characteristic of the write requested data.

20. The SSD system of claim 19, wherein the storage characteristic of the write requested data comprises an update frequency of the write requested data and a life cycle of the write requested data,
wherein the category information refers to a first category corresponding to files having a life cycle shorter than a predetermined time, a second category corresponding to files having an update frequency higher than a predetermined frequency, and a third category corresponding to files having logical addresses allocated in a round-robin manner,
wherein the flash translation layer is configured to map the logical address of the write requested data to the physical address such that the write requested data is selectively stored in a first nonvolatile memory from among the plurality of nonvolatile memories when the write requested data is classified as belonging to the first category based on the category information,
wherein the flash translation layer is configured to map the logical address of the write requested data to the physical address such that the write requested data is selectively stored in a second nonvolatile memory from among the plurality of nonvolatile memories when the write requested data is classified as belonging to the second category based on the category information,
wherein the flash translation layer is configured to map the logical address of the write requested data to the physical address such that the write requested data is selectively stored in a third nonvolatile memory from among the plurality of nonvolatile memories when the write requested data is classified as belonging to the third category based on the category information.
